(19) United States
(12) Patent Application Publication
(10) Pub. No.: US 2018/0149421 A1
(43) Pub. Date: May 31, 2018

(54) Home Appliance Device

(71) Applicant: BSH HAUSGERAETE GMBH, Muenchen (DE)

(72) Inventors: MEHMET CIYANOGLU, ISTANBUL (TR); AYDIN SAHIN, ISTANBUL (TR); TANZER YILDIZGOECER, TEKIRDAG (TR)

(21) Appl. No.: 15/361,569

(22) Filed: Nov. 28, 2016

(51) Int. Cl. F25D 29/00; B23P 19/00

(52) U.S. Cl. CPC F25D 29/006; B23P 19/00

(57) ABSTRACT

For the purpose of improved damage protection a home appliance device it is proposed. The novel device includes at least one cover plate element having at least one cover plate front side, at least one cover plate rear side, and at least one pass-through opening leading from the cover plate front side to the cover plate rear side; and at least one electrical connection unit for connecting to at least one type of electrical plug, the electrical connection unit being arranged on the cover plate rear side behind the pass-through opening and offset, in particular offset rearwards, from the cover plate element.

### BACKGROUND OF THE INVENTION

### Field of the Invention

The invention relates to a home appliance device, in particular a home appliance chiller device.

From the prior art, for instance from documents US 2009/064702 A1 and WO 2010/010031 A1, refrigerators with plug connectors integrated in a surface of a main housing are known.

### SUMMARY OF THE INVENTION

An objective of the invention is, in particular, to provide a home appliance device with improved characteristics regarding damage protection. This objective is achieved, according to the claimed invention. Further implementations and further developments of the invention may be gathered from the dependent claims.

A home appliance device, in particular a home chiller appliance device, is proposed, comprising: at least one cover plate element having at least one cover plate front side, at least one cover plate rear side, and at least one pass-through opening leading from the cover plate front side to the cover plate rear side; and at least one electrical connection unit for connecting to at least one type of electrical plug, the electrical connection unit, in particular a foremost point of the electrical connection unit, being arranged on the cover plate rear side behind the pass-through opening and offset, in particular offset rearwards, from the cover plate element.

By means of the invention in particular a damage protection of the home appliance device can be improved. A plug connection can be included in a home appliance protected from impacts. In particular, a damage to a plug connection, in particular due to impact from rounded or sharp-edged furniture corners, can be avoided. Furthermore, versatility concerning different plug types can be achieved. In addition, one common plate element can be used for different plug types. Easy assembly and/or low manufacturing costs are achieved. Additionally, plug connections can be included in home appliances of different designs in a damage-protected manner.

By a “home appliance device” is in particular to be understood at least a portion, preferably a sub-assembly group, of a home appliance. The home appliance is in particular provided for storing and preferably tempering victuals such as beverages, meat, fish, vegetables, fruits, milk and/or dairy products in at least one operating state, advantageously for the purpose of enhancing a storage life of the stored victuals. Advantageously, the home appliance is embodied as a home chiller appliance, which is in at least one operating state configured for cooling victuals. The home chiller appliance could in particular be embodied as a climate cabinet, an ice-box, a refrigerator, a freezer, a refrigerator-freezer combination and/or a wine cooler. However, the home appliance could also be embodied as a home appliance for warming and in particular for cooking victuals, e.g. an oven, a steamer and/or a microwave.

The home appliance device may comprise at least one inner liner and/or at least one outer liner. The inner liner may be arranged inside the outer liner. In particular, there may be a gap between the inner liner and the outer liner, which may preferably be filled with insulation material, e.g. foam, for instance polyurethane foam. During assembly, the inner liner may be placed inside the outer liner and the gap is subsequently filled with foam during foaming. The inner liner and the outer liner together may form a main housing of the home appliance device.

The cover plate element may implement at least a portion of a side wall section and/or a rear wall section of the home appliance device, particularly of the housing of the home appliance device, for example of the outer liner of the home appliance device. In particular, the cover plate front side faces an exterior of the home appliance device and/or the cover plate rear side faces an interior of the home appliance device. The cover plate element may be made of one piece. In particular, the cover plate element may at least partly or at least to a large extent or completely be made of metal. The cover plate element may in particular be implemented as a stamped or stamped-bent metal part. The cover plate element may be made of sheet metal. It is also conceivable that the cover plate element may at least partly or at least to a large extent or completely be made of plastic. In particular, the cover plate element can be implemented as an injection-molded piece. It is also conceivable that the cover plate element may at least partly or at least to a large extent or completely be made of a laminate. The cover plate element may in particular have an at least substantially constant thickness, e.g. of at least 0.5 mm or of at least 1 mm or of at least 2 mm, and/or of no more than 10 mm or of no more than 5 mm or of no more than 3 mm. In particular, the electrical connection unit may be arranged under-flush with respect to the pass-through opening. “Made of one piece” is, in particular, to mean, in this context, manufactured from one single piece, e.g., by production from one single cast and/or by manufacturing in a one-component or multi-component injection-molding process, and advantageously from a single blank. The term “at least to a large extent” is in particular to mean to an extent of at least 55%, preferably to an extent of at least 65%, further preferably to an extent of at least 75%, advantageously to an extent of at least 85% and further advantageously to an extent of at least 95%. In this context, an “at least substantially constant value” is to be understood as a value that varies by no more than 20%, preferably by no more than 10% and advantageously by no more than 5%.

The cover plate may delimit an insulation area, i.e. an area which is at least partly filled with insulation material, such as insulation foam. In particular, the rear side of the cover plate may at least partly be in contact with insulation material.

The pass-through opening may have a rectangular shape. The pass-through opening may have rounded corners. It is also conceivable that the pass-through opening may be circular, elliptical, polygonal or has an irregular shape.

The home appliance device may comprise at least one electronics unit. In particular, the electrical connection unit may be configured for connecting at least one plug of the at least one type to the electronics unit. For instance, such a plug can be implemented as a power plug, a DCP plug, a USB plug, a network plug, a power charger plug or others. In particular, the electrical connection unit can be configured for providing a charging opportunity for electronic devices, in particular portable electronic devices, including cell phones, smart phones, personal music players, computers, tablet computers, electronic goggles and the like. Additionally or alternatively it is also conceivable that the electrical connection unit may be configured for providing at least one data connection to the electronics unit, for instance for uploading and/or downloading firmware and/or for communicating with the electronics unit in the context of smart home applications. In this context, “configured” is in particular to mean specifically programmed, designed and/or equipped. By an object being configured for a certain function is in particular to be understood that the object implements and/or fulfills said certain function in at least one application state and/or operating state.

The electrical connection unit may in particular be mounted to the cover plate element. In particular, the electrical connection unit may be offset, in particular offset rearwards, from the cover plate element by at least 1 mm or by at least 2 mm or by at least 3 mm or by at least 5 mm, and/or by no more than 20 mm or by no more than 15 mm or by no more than 10 mm or by no more than 8 mm. In this context, an offset distance is preferably measured between a main extension plane of the cover plate element and/or a main extension plane of a surface region of the cover plate directly surrounding the pass-through opening on the one hand and a foremost point of the electrical connection unit on the other hand. In particular, the electrical connection unit may be offset, in particular offset rearwards, from the cover plate element in a direction pointing from the cover plate front side to the cover plate rear side. A “main extension plane” of an object is, in particular, to be understood as a plane extending parallel to a largest side of an imaginary rectangular cuboid which only just entirely encloses the object and preferably extends through a geometric center of the object.

In another embodiment of the invention it is proposed that the electrical connection unit may feature at least one electrical socket with at least one socket opening, which may be arranged behind the pass-through opening and offset, in particular offset rearwards, from the cover plate element. In particular, the socket opening may be offset, in particular offset rearwards, from the cover plate element by at least 1 mm or by at least 2 mm or by at least 3 mm or by at least 5 mm, and/or by no more than 20 mm or by no more than 15 mm or by no more than 10 mm or by no more than 8 mm. In particular, the socket opening may be arranged under-flush with respect to the pass-through opening. The electrical socket may be configured for receiving a plug of the at least one plug type. It is conceivable that the electrical connection unit may feature several, in particular different and/or identical, sockets, for instance two or three or four or five or more, in particular featuring for at least one socket opening each, wherein further the socket openings may be arranged parallel to each other and offset to the cover plate element by a same distance. As a result, damage protection for a plug socket can be provided.

In a further embodiment of the invention, it is proposed that the electrical socket may feature at least one electrical contact element which is arranged behind the socket opening and offset in a direction away from the cover plate rear side. The electrical contact element may be implemented as an electrical contact pin. It is conceivable that the electrical socket features several, in particular identical and/or different, electrical contact elements. A number of electrical contact elements may be adapted to the type of plug. In particular, the electrical contact element may be arranged under-flush with respect to the socket opening. In particular, the electrical contact element may be offset from the socket opening by at least 1 mm or by at least 2 mm or by at least 3 mm or by at least 5 mm, and/or by no more than 20 mm or by no more than 15 mm or by no more than 10 mm or by no more than 8 mm. The electrical contact element may be arranged on a rear side of an interior of the electrical socket. As a result, electrical contacts can be protected from damage while being exposed to an environment.

It is further proposed that the home appliance device may comprise at least one mounting element which may fix the electrical connection unit to the cover plate element and implements the offset. The mounting element may feature at least one front face, which is aligned at least substantially parallel to the cover plate element. The mounting element may in particular be fixed to the cover plate element via at least one screw connection and/or at least one rivet connection and/or at least one gluing connection. The mounting element may feature at least one fixing element which is fixed to the cover plate element, in particular using at least one screw and/or at least one rivet and/or at least one gluing point. The fixing element may implement the offset. In particular, the fixing element may have a depth extension parallel to a depth direction, which at least substantially corresponds to the offset distance. Alternatively or additionally it is conceivable that the mounting element may be latched with the cover plate element. The mounting element may feature at least one support element contacting the cover plate element, which support element in particular sits closely on the cover plate element. The mounting element may be made of one piece. In particular, the mounting element may at least partly be or at least to a large extent or completely made of metal. The mounting element is in particular implemented as a stamped or stamped-bent metal part. For example, the mounting element may be made of sheet metal. It is also conceivable that the mounting element is at least partly or at least to a large extent or completely made of plastic. In particular, the mounting element may be implemented as an injection-molded piece. In this context, by the term “at least substantially” is to be understood that a deviation of a first value from a second value is in particular smaller than 25%, preferably smaller than 10% and advantageously smaller than 5% of the second value. In this context, “at least substantially parallel” is in particular to be understood as an orientation of a direction with respect to a reference direction, in particular in a plane, wherein the direction has a deviation from the reference direction in particular of less than 15°, advantageously of less than 100 and particularly advantageously of less than 2°. As a result, a versatile connection between a housing and a plug socket can be provided.

In addition, it is proposed that the mounting element may feature at least one latching element and that the electrical connection unit is latched to the at least one latching element. The mounting element may feature at least one second latching element for the electrical connection unit. The latching element and/or the second latching element may be configured for fixing the electrical connection unit on at least one side, e.g. a horizontal side. As a result, easy manufacturing is achieved. Furthermore, different plug sockets can be connected to the same type of cover plate using adapted mounting elements.

High strength and/or secure fit can be achieved if the mounting element features at least one, e.g. horizontal, holding bar, wherein the electrical connection unit is interlocked with the at least one, e.g. horizontal, holding bar. For example, the mounting element features at least one first and one second horizontal holding bar, wherein advantageously the horizontal holding bar is configured for holding a bottom of the electrical connection unit, and/or the second horizontal holding bar is configured for holding a top of the electrical connection unit.

Reliable protection against damage, in particular due to impacts by furniture edges and/or corners, can be provided if the mounting element defines at least one impact protection space behind the pass-through opening and in front of the electrical connection unit. In particular, the impact protection space may be delimited by the pass-through opening and the front face of the mounting element. A depth of the impact protection space may correspond essentially to the offset.

Damage protection combined with high handling comfort can be achieved if the mounting element features at least one access opening, through which the electrical connection unit is accessible from the pass-through opening. In particular, the latching element and/or the second latching element and/or the horizontal holding bar and/or the second horizontal holding bar may be arranged at the access opening and in particular defines at least a portion of an edge of the access opening. For example the latching element and the second latching element are arranged on opposing sides, particularly on horizontally opposing sides, of the access opening, in particular at horizontal edges of the access opening. The horizontal holding bar and the second horizontal holding bar may be arranged on opposing sides, in particular on vertically opposing sides, of the access opening.

It is further proposed that the access opening may be of equal size to or of smaller size than the pass-through opening. The access opening may be fully accessible through the pass-through opening. In particular, a size of the access opening may be adapted to a size of the socket opening. The socket opening may be of equal size to or of smaller size than the access opening. In particular, the access opening may be configured for allowing a plug of the at least one type to be passed through. It is conceivable that a shape of the pass-through opening differs from a shape of the access opening. For instance, the pass-through opening can be rectangular, while the access opening may for example be circular or rounded, or vice versa. The shape of the access opening may be similar to a shape of the socket opening. As a result, a common geometry of a pass-through opening can be used for different types of sockets.

Easy and/or cheap manufacturability can be achieved if the electrical connection unit features at least one latching element for mounting the electronics unit to the electrical connection unit. The electronics unit is clicked to the electrical connection unit. It is conceivable that the electronics unit may additionally be attached to and/or latched to and/or pressed against the cover plate element and/or the mounting element.

It is further proposed that an edge region of the pass-through opening may be bent inwards, in particular may be bent in a direction from the front side towards the rear side. This bent edge region may be oriented essentially perpendicular to a main extension plane of the cover plate element and/or a main extension plane of a surface region of the cover plate directly surrounding the pass-through opening. The bent edge region may fully surround the pass-through opening or may only be embodied along certain sections of the edge region, e.g. only along the vertical and/or horizontal sections of the edge region. This bent edge may reduce the risk of injury. In case of a mounting element defining at least one impact protection space behind the pass-through opening, the bent region may in particular be located within the impact protection space.

Favorable properties regarding damage protection can be achieved with a home appliance, in particular a home chiller appliance, comprising at least one home appliance device according to the invention.

Furthermore, a method for assembling a home appliance device, in particular a home chiller appliance device, is proposed, wherein the home appliance device comprises: at least one cover plate element having at least one cover plate front side, at least one cover plate rear side and at least one pass-through opening leading from the front side to the rear side; at least one electrical connection unit for connecting to at least one type of electrical plug, the electrical connection unit being arranged on the cover plate rear side behind the pass-through opening and offset, in particular offset rearwards, from the cover plate element; and at least one mounting element fixing the electrical connection unit to the cover plate element and providing the offset; and wherein in at least one first assembly step the mounting element is attached to the cover plate element, and wherein in at least one second assembly step the electrical connection unit is attached to the mounting element.

Optionally, in at least one third assembly step at least one electronics unit of the home appliance device is attached to the electrical connection unit.

By means of the invention, in particular a damage protection of the home appliance device can be improved. A plug connection can be included in a home appliance protected from impacts. Advantageously, damage to a plug connection, in particular due to impacts from rounded or sharp-edged furniture corners, can be avoided. Furthermore, versatility concerning different plug types can be achieved. In addition, one common cover plate element can be used for different plug types. Advantageously, easy assembly and/or low manufacturing costs is facilitated. Additionally, plug connections can be included in home appliances of different designs in a damage-protected manner.

Herein the home appliance device and/or the method according to the invention are/is not to be limited to the application and implementation described above. In particular, for the purpose of fulfilling a functionality herein described, the home appliance device and/or the method according to the invention may comprise a number of respective elements, structural components, units and/or steps that differ from the number mentioned herein. Furthermore, regarding the value ranges mentioned in this disclosure, values within the limits mentioned are to be understood to be also disclosed and to be used as applicable.

Further advantages may become apparent from the following description of the drawing. In the drawing one exemplary embodiment of the invention is shown. The drawing, the description and the claims contain a plurality of features in combination. The person having ordinary skill in the art will purposefully also consider the features separately and will find further expedient combinations.

If there is more than one specimen of a certain object, only one of these is given a reference numeral in the figures and in the description. The description of this specimen may be correspondingly transferred to the other specimens of the object.

### BRIEF DESCRIPTION OF THE SEVERAL VIEWS OF THE DRAWING

FIG. 1 a home appliance comprising a home appliance device, in a schematic view,

FIG. 2 a portion of the home appliance device, comprising a cover plate element, a mounting element and an electrical connection unit, in a perspective view,

FIG. 3 the mounting element of the home appliance device, in a perspective view,

FIG. 4 a portion of the home appliance device, comprising the cover plate element, the mounting element and the electrical connection unit, in a sectional side view, and

FIG. 5 a schematic flow chart of a method for assembling the home appliance device.

### DETAILED DESCRIPTION OF THE INVENTION

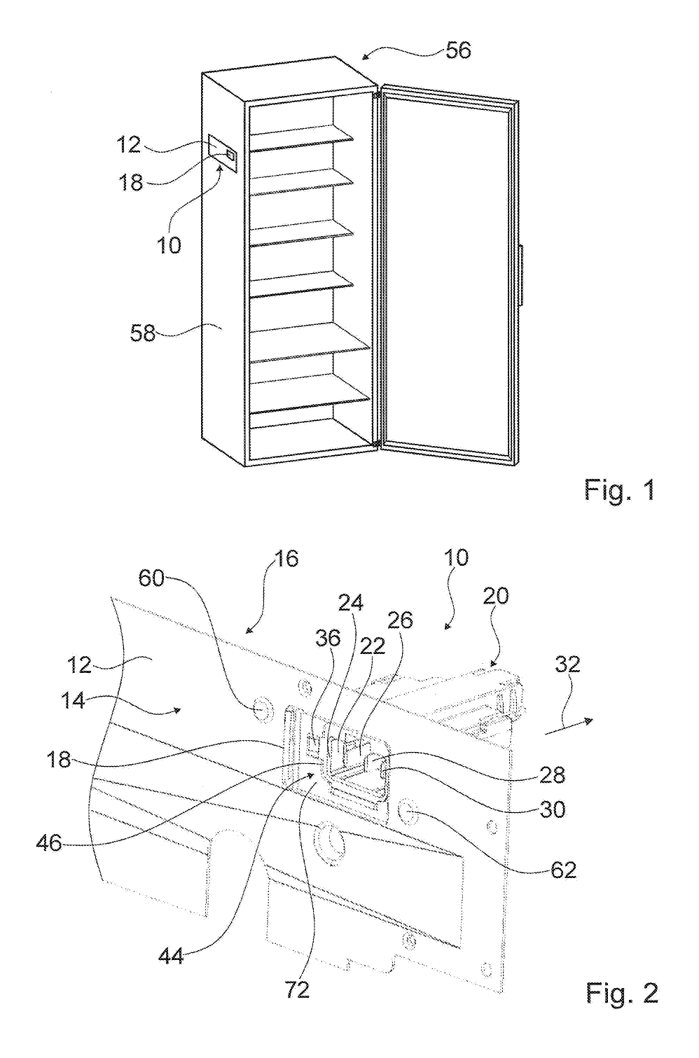

FIG. 1 shows a home appliance 56 comprising a home appliance device 10 in a schematic view. The home appliance 56 is implemented as a home chiller appliance. The home appliance device 10 is implemented as a home chiller appliance device.

FIG. 2 shows a portion of the home appliance device 10 in a perspective view. The home appliance device 10 comprises a cover plate element 12. The cover plate element 12 has a cover plate front side 14 and a cover plate rear side 16. Furthermore, the cover plate element 12 comprises a pass-through opening 18 leading from the cover plate front side 14 to the cover plate back side 16. The home appliance device 10 comprises an electrical connection unit 20 for connecting to at least one type of electrical plug. The electrical connection unit 20 is arranged on the cover plate rear side 16 behind the pass-through opening 18 and offset, in particular offset rearwards, from the cover plate element 12.

The cover plate element 12 is made of a metal sheet. The cover plate element 12 is made of one piece. The cover plate element 12 implements part of an outside wall 58 of the home appliance 56. In the shown embodiment the outside wall 58 is a side wall. However, the cover plate element 12 can be arranged at a different position of the home appliance 56, for instance on a front wall, a door, a top wall, a rear wall and/or behind a door in a similar fashion. The shown positioning of the cover plate element 12 is therefore to be understood only exemplarily.

The electrical connection unit 20 is offset, in particular offset rearwards, from the cover plate element 12 by a few millimeters. In the shown embodiment an offset distance 59 is approximately 5 mm (compare FIG. 4). However, as mentioned above, other distances are conceivable.

The electrical connection unit 20 features at least one electrical socket 22 with at least one socket opening 24. The socket opening 24 is arranged behind the pass-through opening 18 and offset, in particular offset rearwards, from the cover plate element 12. The socket opening 24 defines a foremost point of the electrical connection unit 20. In the shown embodiment the electrical socket 22 is configured for receiving a plug of a charging cable for a portable device. Accordingly, a user is enabled to charge a portable device with power supplied by the home appliance 56. However, as mentioned above, other types of plugs are conceivable. Furthermore, it is conceivable that an electrical contact unit features several, in particular different, similar or identical electrical sockets.

The electrical socket 22 features at least one electrical contact element 28 which is arranged behind the socket opening 24 and offset in a direction 32 away from the cover plate rear side 16. The direction 32 is a depth direction. The electrical contact element 28 is arranged on an interior rear side of the electrical socket 22. The electrical contact element 28 is offset, in particular offset rearwards, from the pass-through opening 18 by approximately 1 cm. In the shown embodiment the electrical socket 22 features a total of three identical electrical contact elements 26, 28, 30. However, as mentioned before, other numbers and/or arrangements and/or shapes of electrical contact elements are conceivable.

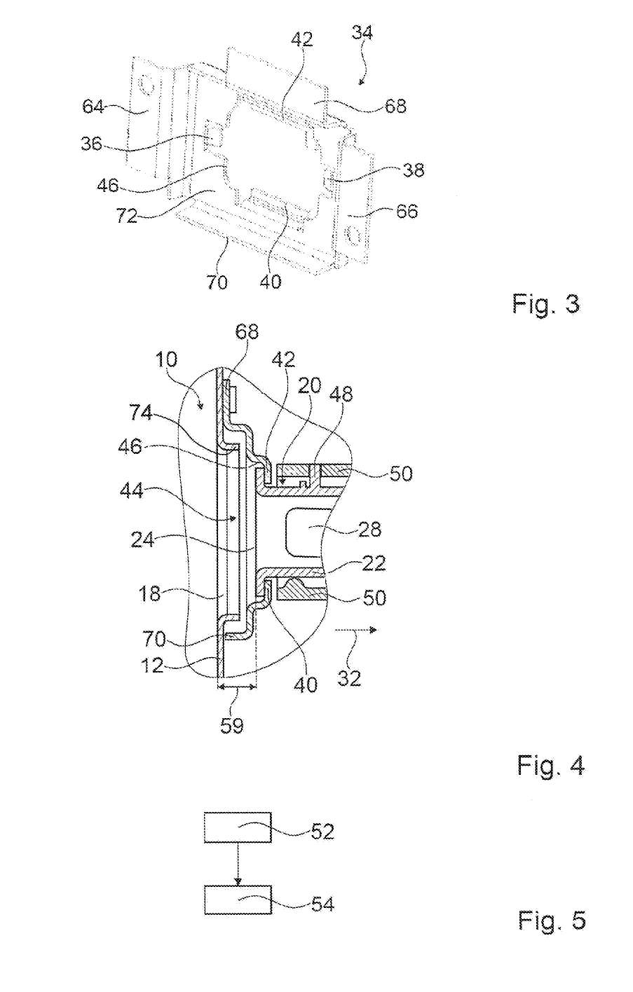

The home appliance device 10 comprises a mounting element 34 fixing the electrical connection unit 20 to the cover plate element 12 and implementing the offset. The mounting element 34 is shown in a perspective view in FIG. 3. A sectional side view of a portion of the home appliance device 10 comprising the cover plate element 12, the mounting element 34 and the electrical connection unit 20 is shown in FIG. 4.

The mounting element 34 is made of metal. The mounting element 34 is made of one piece. The mounting element 34 is made of a metal sheet. The mounting element 34 is connected to the cover plate element 12 via a rivet connection. The rivet connection comprises two rivets 60, 62. The mounting element 34 comprises two fixing element 64, 66. The fixing elements 64, 66 are fixed to the cover plate element 12, in particular by means of the rivets 60, 62. Furthermore, the mounting element 34 comprises two support elements 68, 70 sitting closely on the cover plate element 12. In a similar fashion mounting elements with different geometries, for instance configured for mounting other types of sockets and/or other types of electrical connection units, can be mounted to the cover plate element 12. Thus, when adapting the home appliance device 10 to other plug types, the same cover plate element 12 can be used.

The mounting element 34 features a front face 72. The front face 72 is arranged behind the pass-through opening 18 and is offset, in particular offset rearwards, from the cover plate element 12.

The mounting element 34 defines an impact protection space 44 behind the pass-through opening 18. The impact protection space 44 is arranged between the cover plate element 12 and the front face 72 of the mounting element 34. The impact protection space 44 is at least partly limited by the fixing elements 64, 66. The impact protection space 44 is at least partly limited by the support elements 68, 70. Potentially damaging objects penetrating through the pass-through opening 18, for instance furniture corners, must pass through the entire impact protection space 44 before touching the electrical connection unit 20.

The mounting element 34 features an access opening 46, through which the electrical connection unit 20 is accessible from the pass-through opening 18. When a plug is plugged into the electrical socket 22, the plug is passed through the pass-through opening 18, the access opening 46 and the socket opening 24, in particular in the direction 32. The access opening 46 is arranged behind the pass-through opening 18. The access opening 46 is fully accessible through the pass-through opening 18. The access opening 46 is of equal size to or of smaller size than the pass-through opening 18. In the shown embodiment the access opening 46 is smaller than the pass-through opening 18.

The mounting element 34 features at least one latching element 36. The electrical connection unit 20 is latched to the latching element 36. The latching element 36 is arranged at an edge of the access opening 46. In the shown embodiment the mounting element 34 features a second latching element 38. The latching element 36 and the second latching element 38 are arranged at opposing edges of the access opening 46.

The mounting element 34 features at least one horizontal holding bar 40. The electrical connection unit 20 is interlocked with the horizontal holding bar 40. In the shown embodiment the mounting element 34 features a second horizontal holding bar 42. The holding bar 40 and the second holding bar 42 are arranged at opposing edges of the access opening 46. The holding bar 40 and the second holding bar 42 are configured for carrying a weight of the electrical connection unit 20.

The electrical connection unit 20 features a latching element 48 for mounting at least one electronics unit 50 to the electrical connection unit 20. In the shown embodiment the electronics unit 50 features electronics for providing a charging function for portable devices. The electronics unit 50 is only partly shown in FIG. 4. The electronics unit 50 is electrically connected to the electrical connection unit 20, in particular to the electrical socket 22. A plug is connectable to the electronics unit 50 via the electrical connection unit 20, in particular via the electrical socket 22. The electronics unit 50 is latched to the electrical connection unit 20. A weight of the electronics unit 50 is at least partly transmitted to the cover plate element 12 via the electrical connection unit 20 and the mounting unit 34.

As shown in FIG. 4 the edge region 74 of the pass-through opening 18 of the cover plate element 12 is bent. That is, said edge region 74 is bent inwards from the front side 14 towards the rear side 16. The bent edge region 74 is essentially completely located within the impact protection space 44. This reduces the risk of injuries, since sharp corners of the pass-through opening 18 are located such that fingers of a user are less likely to contact them.

FIG. 5 shows a schematic flow chart of a method for assembling the home appliance device 10. In a first assembly step 52, the mounting element 34 is attached to the cover plate element 12, in particular using the rivets 60, 62. In a second assembly step 54, the electrical connection unit 20 is attached to the mounting element 34, in particular to the latching elements 36, 38 and the horizontal holding bars 40, 42.

The following is a summary list of reference numerals and the corresponding structure used in the above description of the invention:
10 home appliance device
12 cover plate element
14 cover plate front side
16 cover plate rear side
18 pass-through opening
20 electrical connection unit
22 electrical socket
24 socket opening
26 electrical contact element
28 electrical contact element
30 electrical contact element
32 direction
34 mounting element
36 latching element
38 latching element
40 holding bar
42 holding bar
44 impact protection space
46 access opening
48 latching element
50 electronics unit
52 assembly step
54 assembly step
56 home appliance
58 outside wall
59 offset distance
60 rivet
62 rivet
64 fixing element
66 fixing element
68 support element
70 support element
72 front face
74 edge region

1. A home appliance device, in particular a home chiller appliance device, comprising:
at least one cover plate element having at least one cover plate front side, at least one cover plate rear side, and at least one pass-through opening leading from the cover plate front side to the cover plate rear side;
at least one electrical connection unit for connecting to at least one type of electrical plug, the electrical connection unit being arranged on the cover plate rear side behind the pass-through opening and offset, in particular offset rearwards, from the cover plate element;
at least one mounting element which fixes the electrical connection unit to the cover plate element and implements the offset, wherein said mounting element features at least one latching element; the electrical connection unit being latched to the at least one latching element.

2. The home appliance device according to claim 1, the electrical connection unit featuring at least one electrical socket with at least one socket opening which is arranged behind the pass-through opening and offset, in particular offset rearwards, from the cover plate element.

3. The home appliance device according to claim 2, the electrical socket featuring at least one electrical contact element which is arranged behind the socket opening and offset in a direction away from the cover plate rear side.

4-5. (canceled)

6. The home appliance device according to claim 4, the mounting element featuring at least one horizontal holding bar the electrical connection unit being interlocked with the at least one horizontal holding bar.

7. The home appliance device according to claim 4, the mounting element defining at least one impact protection space behind the pass-through opening and in front of the electrical connection unit.

8. The home appliance device according to claim 4, the mounting element featuring at least one access opening, through which the electrical connection unit is accessible from the pass-through opening.

9. The home appliance device according to claim 8, the access opening being of equal size to or of smaller size than the pass-through opening.

10. The home appliance device according to claim 1, the electrical connection unit featuring at least one latching element for mounting at least one electronics unit to the electrical connection unit.

11. A home appliance, in particular a home chiller appliance, comprising at least one home appliance device according to claim 1.

12. A method for assembling a home appliance device, comprising: at least one cover plate element having at least one cover plate front side, at least one cover plate rear side, and at least one pass-through opening leading from the cover plate front side to the cover plate rear side; at least one electrical connection unit for connecting to at least one type of electrical plug, the electrical connection unit being arranged on the cover plate rear side behind the pass-through opening and offset, in particular offset rearwards, from the cover plate element; and at least one mounting element fixing the electrical connection unit to the cover plate element and providing the offset; wherein in at least one first assembly step the mounting element is attached to the cover plate element, and wherein in at least one second assembly step the electrical connection unit is attached to the mounting element.

13. The method according to claim 12, wherein the home appliance to be assembled is a home chiller appliance.

14. The method according to claim 12, wherein the home appliance device to be assembled is a home chiller appliance according to claim 1.
